(19) United States
(12) Patent Application Publication
(10) Pub. No.: US 2014/0374334 A1
(43) Pub. Date: Dec. 25, 2014

(54) FILTER DEVICE AND FILTER ELEMENT FOR SUCH A FILTER DEVICE

(71) Applicant: Hydac Filter System GmbH, Sulzbach/Saar (DE)

(72) Inventors: Dominic Schneider, Namborn (DE); Andreas Schunk, Waldmohr (DE)

(21) Appl. No.: 13/261,935

(22) PCT Filed: Jan. 17, 2013
(86) PCT No.: PCT/EP2013/000119

§ 371 Date: Aug. 4, 2014

(30) Foreign Application Priority Data
Feb. 9, 2012 (DE) 10 2012 002 534.3

(51) Int. Cl. B01D 35/06

(52) U.S. Cl. CPC B01D 35/06
USPC 210/223

(57) ABSTRACT

The invention relates to a filter device comprising at least one filter element, said filter element having an inner fluid space (4), and comprising a permanent magnet device with at least one rod-like body (13) that can be brought into a functional position, in which it is located at least in part inside the fluid space (4), and can be moved out of the functional position, the device being characterized in that a stripping device is provided, with at least one stripping element (29, 31) which, while the respective body (13) is being moved out of the functional position, comes into contact with the exterior thereof in order to strip off accumulated foreign matter.

The present invention relates to a filter device comprising at least one filter element which can be accommodated in a housing and which includes an inner fluid space, and comprising a permanent magnet device with at least one rod-like body that can be brought into a functional position, in which it is located at least in part inside the fluid space, and can be moved out of the functional position. The invention also relates to a filter element for such a filter device.

Filter devices of this kind are the prior art, see DE 10 2008 012 521 A1. When using such filter devices in technical facilities, such as hydraulic systems, an effective additional filtering or pre-filtering of the fluid to be cleaned, such as hydraulic fluid, is achieved with the aid of a permanent magnet device located in the fluid space of such filter elements, in that metallic foreign matter that is magnetizable may be separated from the fluid by accumulating on the permanent magnetic device. Preferably, a permanent magnet device in the form of a so-called magnetic core is used in such a configuration, which has the shape of an elongated, rod-like body. As this is the case with the aforementioned, known filter device, it is possible for the rod-like body, when situated in the functional position, to extend along the central axis of the filter element in question inside the fluid space in such a way that the exterior thereof comes, for all practical purposes, into full contact with the fluid.

In the course of maintenance and repair, as is the case each time the filter element is replaced or when an appropriately large amount of foreign matter has accumulated, it is necessary to move the rod-like body out of the functional position and to clean it before again returning it to the functional position. The corresponding cleaning, including wiping the body with cleaning cloths, in which measures must be taken to avoid contaminating the environment with the removed contaminants, becomes laborious and time-consuming.

In view of these problems, the object of the present invention is to provide a filter device of the kind under consideration, which may be operated with relatively little maintenance.

According to the invention, this object is achieved by a filter device which includes the features of patent claim 1 in its entirety.

An essential specific feature of the invention, accordingly, is the provision of a stripping device which, as a respective rod-like body is being moved out of the functional position, comes into contact with the exterior of the body with at least one stripping element in order to strip off accumulated foreign matter. In this way, a cleaning process is carried out simultaneously with the removal of the body from the fluid space, such that no additional cleaning measures, such as wiping with cleaning cloths, are required on the body when situated outside the filter element. Not only does this reduce the expenditure of labor, but at the same time avoids the danger of contaminating the environment, in that the rod-like body is already freed of foreign matter when it is removed from the fluid space.

Stripping elements of the stripping device may be advantageously formed by wall sections of an opening, through which the respective body may be moved when being moved out of the functional position.

A particularly effective wiping process, i.e., an efficient cleaning of the body is achieved, in particular, in that at least a portion of the wall sections of the opening when pre-tensioned flexibly acts on the exterior of the respective body. In this way, the wall sections of the opening are able to cling to the respective outer contour of the rod-like body, allowing an optimal wiping process to take place.

In particularly advantageous exemplary embodiments, in which a filter element is provided with at least one end cap disposed on one end thereof, the stripping device is provided on the end cap. This results first of all in a particularly simple and cost-efficient construction, and secondly in the significant additional advantage that the foreign matter stripped from the end cap remains completely within the fluid space and is disposed of together with the filter element in question when the latter is replaced.

With regard to the design of the end cap, the latter may be advantageously constructed so that the end cap includes an annular body with a cross-member that bridges the body in the manner of a spoke, the opening which forms the stripping element being provided in the central area of the cross-member. In particularly advantageous exemplary embodiments, the cross-member is provided with at least one slot, which merges with the opening to impart flexibility to the wall of the opening.

The wall of the opening may particularly advantageously include two conical surfaces which expand from the middle area of the opening axially outwardly. The fact that the opening is expanded on both sides allows the narrowest point of the opening to have an initial inner diameter which is smaller than the outer diameter of the rod-like body, because the body is able to enter through the expanded end before the opening is widened such that at its narrow point it rests exactly flush against the body.

In particularly preferable exemplary embodiments, the outer end of the rod-like body is attached to a support accessible from the exterior of the filter element, by means of which the body may be handled. A handle designed in such a way allows the rod-like body to be conveniently moved out of and into the functional position.

The support may preferably include multiple arms which, starting from a central attachment piece for the rod-like body, extend angularly toward one another and are releasably attachable at their ends to the annular body of the end cap.

According to claim 11, the subject matter of the invention is also a filter element for a filter device according to one of claims 1 through 10. An embodiment of the filter element is specified in the subsequent dependent claim 12.

The invention is described in detail below with reference to an exemplary embodiment depicted in the drawings, in which:

FIG. 1 shows a longitudinal section of a filter element for an exemplary embodiment of the filter device according to the invention;

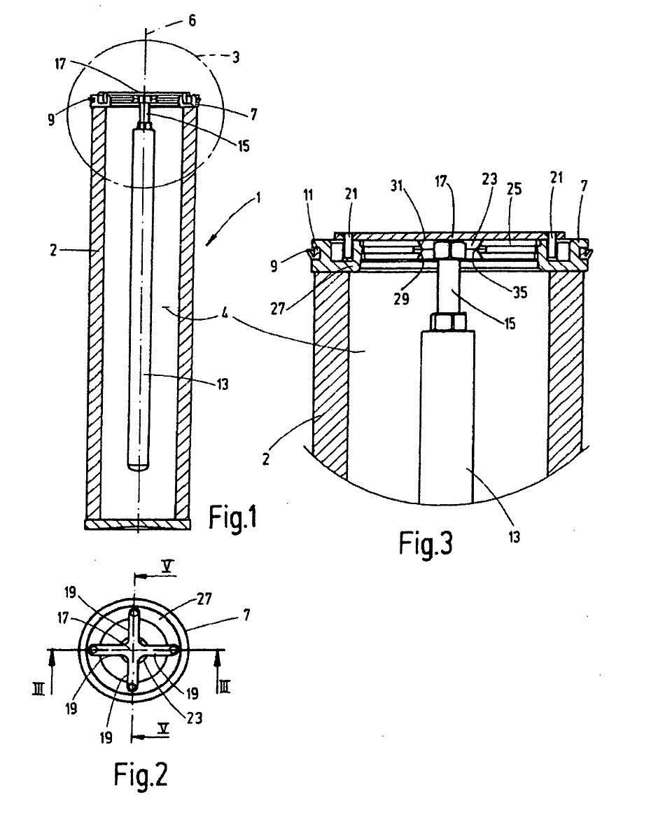

FIG. 2 shows a top view of the filter element of FIG. 1;

FIG. 3 shows an enlarged, partial longitudinal section of the area of the filter elements identified by numeral 3 in FIG. 1;

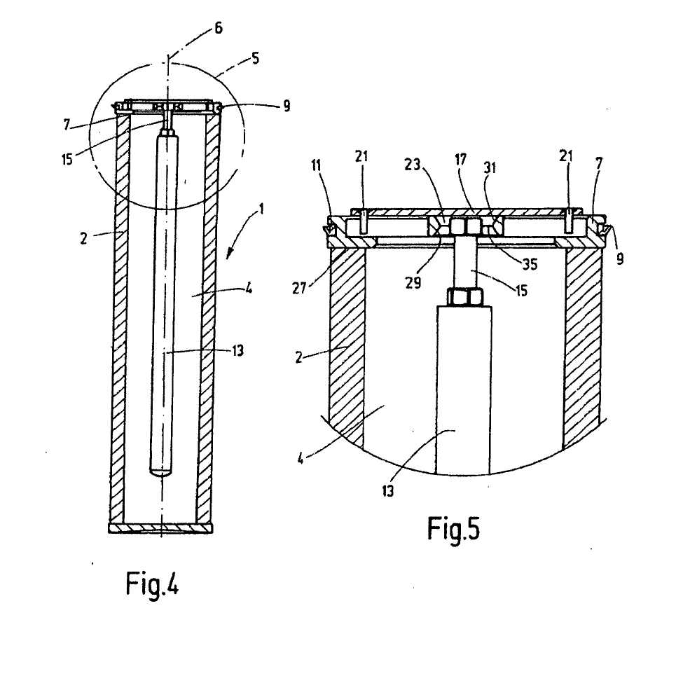

FIG. 4 shows a longitudinal section, which shows the filter element in a position rotated 90° relative to FIG. 1;

FIG. 5 shows an enlarged, partial longitudinal section of the area identified by numeral 5 in FIG. 4;

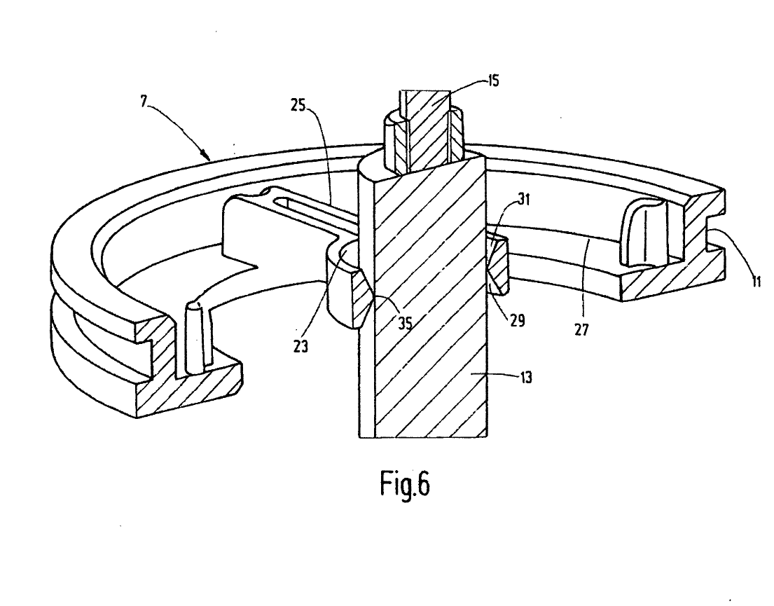

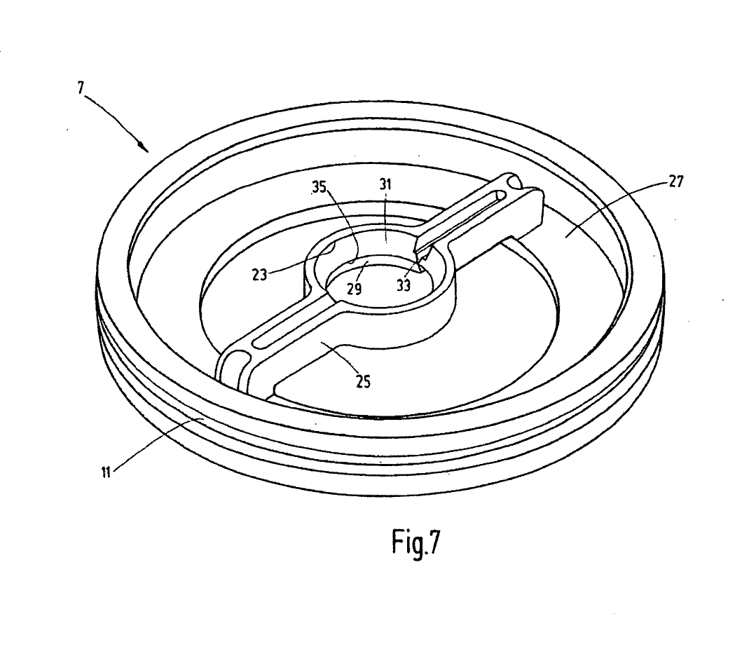

FIG. 6 shows an even greater enlarged and cross-sectioned perspective oblique view of the end cap of the filter element and of a portion of a permanent magnetic device, and

FIG. 7 shows a perspective diagonal view of the separately depicted end cap.

The filter device according to the invention is described based on an exemplary embodiment with reference to the drawings, in which a filter element 1 includes a filter medium 2, which has the shape of a hollow cylinder that defines an inner fluid space 4 extending along a vertical axis 6. An end cap is located at the upper end of the fluid space 4 in the drawing, which encloses the adjacent end of the filter medium 2, and on the peripheral edge of which a sealing assembly 9 is disposed in an annular groove 11, which forms a seal with respect to a housing not shown.

FIGS. 1 through 6 each show a permanent magnet device in its functional position. The permanent magnet device includes a so-called magnetic core, which has the shape of a rod-like body 13 which, in its functional position, extends along the vertical axis 6 within the fluid space 4. The rod-like body 13 is screwed at its upper end in the drawing to a connecting shaft 15 which, in turn, is connected to a support 17. As shown in the top view in FIG. 2, the support 17 is designed with four arms and has four arms 19 disposed at right angles to each other (see FIG. 2), which are connected to the end cap 7 via screws 21 (FIGS. 3 and 5).

The support 17, which is accessible from the outside of the filter element 2, is used not only to fix the rod-like body 13 in the functional position, but also forms a handle for removing the rod-like body 13 from the fluid space 4 when needed, i.e., during maintenance, such as replacing the filter element. A stripping device is provided in the filter device according to the invention, which combines the removing step with a cleaning step, in which the magnetizable foreign matter that has accumulated on the exterior of the rod-like body 13 is stripped off, thus eliminating the need clean the body 13 removed from the filter element 1. In the invention, the stripping device is formed on the end cap 7 in such a way that stripped off accumulations drop directly into the fluid space below and thus, may be disposed of together with a filter element 1 to be replaced in an ecologically friendly manner without polluting the environment.

The stripping device 1 is formed by an opening 23 in the end cap 7 concentric to the central axis 6, which is located on a cross-member 25 (FIGS. 6 and 7) extending on the end cap 7 between the outer annular body 27 thereof. The inner wall sections 29 and 31 of the inside of the opening 23 function as stripping elements, which rest flush against the outside of the body when the rod-like body 12 is moved out of the fluid space 4, and which wipe away the accumulated foreign matter during the axial movement. As is seen most clearly in FIG. 6, the inner wall sections 29, 31 of the opening 23 form conical surfaces which, starting from the middle area, expand the opening 23 toward both axial ends. In the initial state, the opening 23 is dimensioned in such a way that the middle area, forming a narrow point between the conical surfaces, defines an inner diameter which is somewhat smaller than the outer diameter of the rod-like body 13. In addition, the cross-member 25, which includes the opening 23, is slotted in such a way that longitudinal slots merge from both opposing sides into the opening 23, of which only one longitudinal slot 33 is visible in FIG. 7. In this way, the opening 23 may be flexibly expanded when the rod-like body 13 is moved through the opening 23, whereby the body 13 enters easily and conveniently each time as a result of the expansions at the ends of the cones of the wall sections 29, 31, and the middle area between the wall sections 29, 31, being flexibly pre-tensioned, (see FIG. 6) rests flush against the body 13 as a wiping edge 35.

1. A filter device having at least one filter element (1), which includes an inner fluid space (4), and comprising a permanent magnet device with at least one rod-like body (13), which can be moved into a functional position, in which it is situated at least in part inside the fluid space (4), and can be moved out of the functional position, characterized in that a stripping device is provided, with at least one stripping element (29, 31) which, as the respective body (13) is being removed from the functional position, comes into contact with the exterior thereof in order to strip off accumulated foreign matter.

2. The filter device according to claim 1, characterized in that stripping elements are formed by wall sections (29, 31) of an opening (23), through which the respective body (13) may be moved when it is removed from the functional position.

3. The filter device according to claim 1, characterized in that at least a part of the wall sections (29, 31) of the opening (23), being pre-tensioned, flexibly acts on the exterior of the respective body (13).

4. The filter device according to claim 1, characterized in that a filter element (1) is provided with at least one end cap (7) situated at an end thereof and that the stripping device (29, 31) is provided on the end cap (7).

5. The filter device according to claim 1, characterized in that the end cap (7) includes an annular body (27) with a cross-member (25) bridging it in the manner of a spoke, and that the opening (23) which forms the stripping elements (29, 31) is provided in the central area of the cross-member (25).

6. The filter device according to claim 1, characterized in that the cross-member (25) is provided with at least one slot (33) merging into the opening (23) to impart flexibility to the wall sections (29, 31) of the opening (23).

7. The filter device according to claim 1, characterized in that the cross-member (25) is an integral component of the end cap (7).

8. The filter device according to claim 1, characterized in that the opening (23) includes wall sections in the form of two conical surfaces (29, 31), which expand from the middle area of the opening (23) axially outwardly.

9. The filter device according to claim 1, characterized in that the outer end of the rod-like body (13) is attached to a support (17) accessible from the exterior of the filter element (1), with which the body (13) may be manipulated.

10. The filter device according to claim 1, characterized in that the support (17) includes multiple arms (19) which, starting from a central attachment piece for the rod-like body (13), extend angularly toward one another and are releasably attachable at their ends to the annular body (27) of the end cap (7).

11. A filter element for a filter device according to claim 1, characterized in that it includes near one end of its inner fluid space (4) a stripping device having at least one stripping element (29, 31) which, as a permanent magnet device comprising a rod-like body (13) is moved out of the fluid space (4), comes into contact with the exterior of the body (13) in order to strip off accumulated foreign matter.

12. The filter element according to claim 11, characterized in that the stripping device (29, 31) is formed by a component of an end cap (7) situated at one end of the fluid space (4).
